(19) United States
(12) Patent Application Publication
(10) Pub. No.: US 2013/0256522 A1
(43) Pub. Date: Oct. 3, 2013

(54) TITANIUM BASED GAS RESERVOIR FOR LOW POWER SEALED TUBE NEUTRON GENERATORS

(71) Applicants: Luke T. Perkins, Plainsboro, NJ (US); Dylan Leber, Bordentown, NJ (US)

(72) Inventors: Luke T. Perkins, Plainsboro, NJ (US); Dylan Leber, Bordentown, NJ (US)

(21) Appl. No.: 13/433,085

(22) Filed: Mar. 28, 2012

(51) Int. Cl. H05H 3/06; G01V 5/10

(52) U.S. Cl. 250/259; 376/111; 250/269.4; 250/269.5

(57) ABSTRACT

A pulsed neutron generator includes a sealed tube. a gas reservoir is disposed in the sealed tube and includes an electrically heatable filament disposed within a porous, sintered getter. The getter includes dispersed particles of a thermally reversible hydride-adsorptive material therein. The dispersed particles have deuterium and/or tritium adsorbed on them. A gas ionizer disposed in the sealed tube. A target is disposed in the sealed tube. The target includes adsorbed deuterium and/or tritium therein.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

The disclosure relates generally to the field of sealed tube neutron generators. More specifically, the disclosure relates to structures for a gas reservoir used in such neutron generators.

A pulsed neutron generator (PNG), which may include a sealed tube, controllable power supplies and high voltage insulation system disposed in a housing, is used, for example, in various types of well logging instruments. The PNG emits high energy (approximately 14 MeV) bursts of neutrons that interact with subsurface formations surrounding a wellbore into which the instrument is inserted. Various types of detectors, e.g., gamma ray detectors, epithermal neutron detectors and thermal neutron detectors may be disposed on the instrument at selected axial distances from the PNG. Numbers of, timing of and/or energy levels of detected neutrons and/or gamma rays may be used to determine selected physical properties of the formations. One example of a PNG tube is described in U.S. Pat. No. 5,293,410 issued to Chen et al.

Typical PNGs include a gas reservoir to maintain a selected pressure of deuterium and/or tritium gas within the sealed envelope or tube. During operation of the PNG, the deuterium and/or tritium gas released by the reservoir is typically ionized and accelerated by a high gradient electric field toward a target, which itself may include adsorbed deuterium and/or tritium. Reaction between the accelerated gas ions and adsorbed gas atoms in the target results in a fusion reaction which releases neutrons.

The gas reservoir is typically a wound wire filament with metal(s) (e.g., Zr, Ti, Sc, Er, V, etc.) which adsorbed hydrogen gas atoms therein. The filament is heated by passing electric current through it. Pressure of the gas may be maintained at a selected value by controlling the amount of current passed through the filament. The current used to heat the filament may constitute a substantial fraction of the total power consumed by the PNG. Filaments are also relatively weak structures and can cause parasitic heating of nearby neutron tube components.

There continues to be a need for improved PNG structures.

### SUMMARY

A pulsed neutron generator includes a sealed neutron tube. A gas reservoir is disposed in the sealed tube and includes an electrically heatable filament disposed within a porous, sintered getter. The getter includes dispersed particles of a thermally reversible hydride adsorptive material therein. The dispersed particles have deuterium and/or tritium adsorbed on them. A gas ionizer is also disposed in the sealed tube. A target is disposed in the sealed tube. The target includes adsorbed deuterium and/or tritium therein.

A method for generating neutrons includes filling an evacuated, sealed envelope with deuterium and/or tritium gas to a selected pressure by heating a sintered, porous getter having deuterium and/or tritium adsorbed in thermally reversible hydride adsorptive particles dispersed in the getter. The deuterium and/or tritium gas is ionized. The ionized gas is accelerated to strike a target in the sealed envelope. The target has adsorbed deuterium and/or tritium therein, whereby the accelerated ions react with the adsorbed deuterium and/or tritium in the target to release neutrons.

Other aspects and advantages will be apparent from the description and claims which follow.

### BRIEF DESCRIPTION OF THE DRAWINGS

FIG. 1 shows an example sealed neutron generator tube.

FIG. 2 shows an example getter-based gas reservoir for the neutron tube in more detail.

FIG. 3 shows an example wireline conveyed well logging instrument that may use a neutron generator tube as in FIG. 1.

FIG. 4 shows a while drilling well logging instrument that may use a neutron generator tube as in FIG. 1.

### DETAILED DESCRIPTION

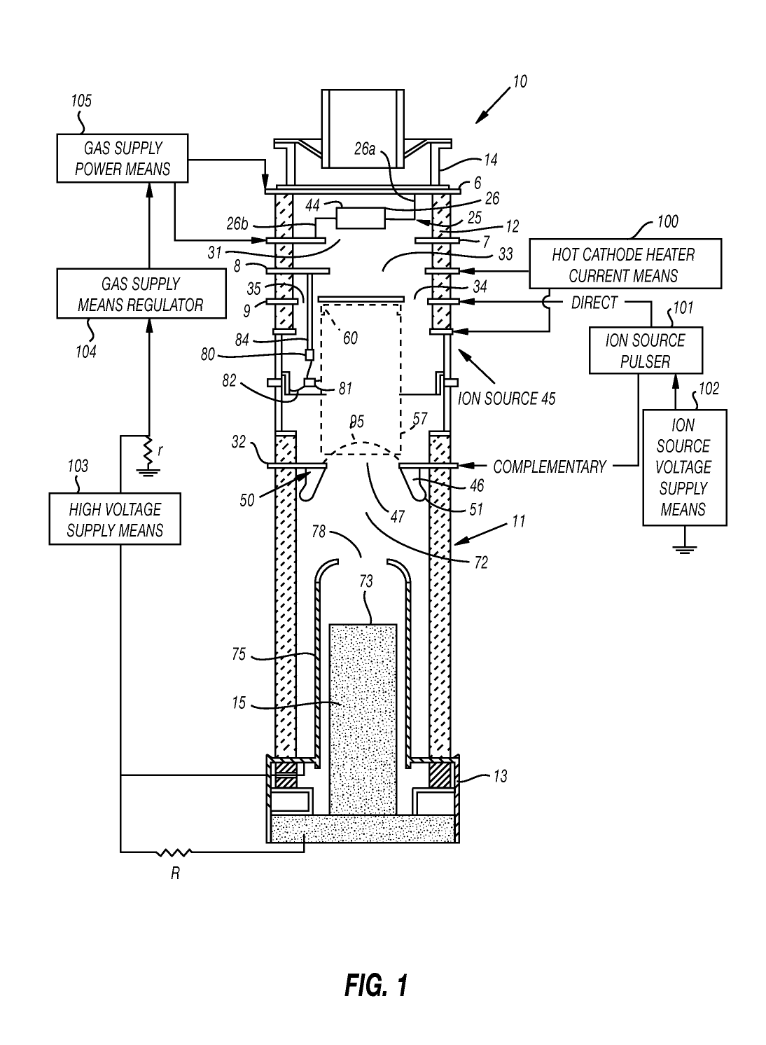

An example neutron tube used in a pulsed neutron generator (PNG) will be explained with reference to FIG. 1. The neutron generator 10 may include a hollow cylindrical tube 11 made of an insulating material such as alumina ceramic and having its respective longitudinal extremities fixed to a ceramic ring 12 and a conductive ring 13, an ion source 45, a gas reservoir 25, an extracting electrode 50, and a copper target electrode 15. A transverse header 14 and the target electrode 15 close the ceramic rings 12 and 13, respectively, to provide a gas-tight, hermetic cylindrical envelope. Ceramic ring 12 comprises parallel transversely disposed flanges 6, 7, 8, and 9, to provide electrically conductive paths and structural support for the neutron tube components as described subsequently in more complete detail. Flanges 6-9 may be substantially equally spaced along ring 12, between header 14 and the corresponding extremity of the cylindrical tube 11. The gas reservoir 25 may be disposed transversely or axially with respect to the longitudinal axis of the neutron generator 10, between the first flange 6 and the second flange 7, closest to the header 14. The gas reservoir 25 comprises a helically wound filament 26 which may be made of tungsten or other electrically resistive metal, and which may be heated to a predetermined temperature by an electric current from a controllable power supply 105 to which both ends 26a and 26b of filament 26 are connected.

The filament is 26 disposed within a getter 44 made of a sintered, porous material. The filament 26 is heated electrically by passing therethrough electric current from the controllable power supply in order to heat the surrounding getter 44 to provide a supply of deuterium and or tritium gas in the interior of the cylindrical tube 11, and control gas pressure during neutron generator 10 operation.

The gases desorbed by the getter 44 spread through holes provided in flanges 7-9, e.g., a hole 31 in the second flange 7, a hole 33 in the third flange 8 and holes 34, 35 in the fourth flange 9. The gases desorbed enter an ion source 45 which may be interposed between the gas reservoir 25 and the extremity of the tube 11 facing ceramic ring 12. An annular shaped electrical insulator 90 may be interposed between the tube 11 and the ceramic ring 12.

The ion source 45 may comprises a cylindrical, hollow anode 57 aligned with the longitudinal axis of the generator 10 and may be in the form of either a mesh or a coil. Typically, a positive ionizing potential (either direct or pulsed current) in the range of 100-300 volts relative to a cathode 80, is applied to the anode 57. In one example, the anode 57 may be about 0.75 inch (1.9 cm) long and may have a diameter of approximately 0.45 inch (1.14 cm). The anode 57 is typically secured rigidly to the fourth flange 9, e.g. by conductive pads 60.

The ion source 45 may also include the cathode 80 being disposed close to the outside wall of the anode 57, in a substantially median position with respect to the anode 57. The cathode 80 may include an electron emitter 81 comprising a block of material susceptible, when heated, to emit electrons. The emitter 81 may be fixed (e.g., by brazing) to a U-shaped end 82 of an arm 84 being itself secured to the third flange 8. The arm 84 also may provide an electrical connection between the emitter 81 and a hot cathode heater power supply 100 able to generate, e.g., a few watts for heating the electron emitter 81. Heater current 100 may be selected according to what is described in e.g., U.S. Pat. Nos. 3,756,682, 3,775,216 or 3,546,512 incorporated herein by reference.

The thermionic cathode 80 of the ion source of the present invention is preferably of the “dispenser” or “volume” type. A dispenser cathode used in a hydrogen environment maximizes electron emissions per heater power unit compared to other thermionic type cathodes (such as LaB₆ or W), while operating at a moderate temperature. The emitter block 81 comprises a substrate made of porous tungsten, impregnated with a material susceptible to emit electrons, such as compounds made with combinations of e.g. barium oxide and strontium oxide. Each cathode has different susceptibility to their operating environment (gas pressure and gas species). Dispenser cathodes are known to be the most demanding in terms of the vacuum requirements and care that is needed to avoid contamination. Possible advantages of using a dispenser cathode as explained herein may include that the PNG may be operable as long as several hundred hours in a hydrogen gas environment of pressure on the order of several mTorr, providing an peak electron emission current of from 50 to 80 mA yet requiring only a few watts of heater power.

The cathode 80 may be provided with current from a the cathode heater power supply 100, which is distinct from an ion source voltage supply 102. Such implementation permits a better control of both the cathode heater power supply 100 and the ion source voltage supply 102. It should be clearly understood that using the foregoing dispenser type cathode is not a limitation on the scope of PNG tube structures that may be used. The gas reservoir 25 may be used equally with Penning-type (cold cathode) PNG tubes to provide an even lower power consumption neutron tube.

An extracting electrode 50 may be disposed at the end of the ion source 45 facing target 15, at the level of the junction between the tube 11 and the ring 12. The extracting electrode 50 may be supported in fixed relation to the ring 12 by a fifth flange 32. The extracting electrode 50 may include a massive annular body 46, e.g., made of nickel or an alloyed metal such as one sold under the trademark KOVAR, which is a registered trademark of CRS Holdings, Inc., 1105 North Market Street Suite 601 Wilmington Del. 19801. The annular body 46 may be in alignment with the longitudinal axis of the tube 11. A central aperture 47 in the body 46 diverges outwardly in a direction away from the ion source 45 to produce at the end of body 46 facing target electrode 15 a torus-shaped contour 51. The contour 51 reduces a tendency to voltage breakdown that is caused by high electrical field gradients.

Moreover, the extracting electrode 50 may provide one of the electrodes for an accelerating gap 72 that impels ionized deuterium and tritium particles from the ion source 45 toward a deuterium- and/or tritium-filled target 73. The target 73 comprises a thin film of titanium, scandium or other known hydride system deposited on the surface of the transverse side, facing ion source 45, of the target electrode 15.

The potential that accelerates the ions to the target 73 is established, to a large extent, between the extracting electrode 50 and a suppressor electrode 75 hereafter described. The suppressor electrode 75 may be a concave member that is oriented toward the target electrode 15 and has a centrally disposed aperture 78 which enables the accelerated ions to move from the gap 72 to the target 73. The aperture 78 is disposed between the target 73 and the extracting electrode 50. The suppressor electrode 75 is connected to a high voltage power supply 103 which may also be connected, through a resistor “R” to ground potential. In order to prevent electrons from being extracted from the target 73 upon ion bombardment (these extracted electrons being called “secondary electrons”), the suppressor electrode 75 is held at a negative voltage with respect to the voltage of the target electrode 15.

The velocity of the ions leaving the ion source 45 is, on an average, relatively lower than ion velocity in a known Penning source. Consequently, the ions tend to generate a tail in the neutron pulse, at the moment the voltage pulse to the ion source 45 is turned off. The presence of an end tail is detrimental to the neutron pulse shape (i.e., numbers of neutrons generated with respect to time which is of importance. The example PNG structure remedies this situation by adding to the extracting electrode 50, a cut-off electrode 95, which may be in the form of a mesh screen 95 and which may be fixed, e.g., by welding, to the aperture 47 of the extracting electrode 50, facing the ion source 45. The mesh screen 95 (cut-off electrode) may be made of, for example, high transparency molybdenum. The cut-off electrode 95 has applied thereto voltage pulses synchronized with and complementary to the voltage pulses applied to the ion source anode 57. The pulses applied to the cut-off electrode 95 are positive and may be on the order of 100 to 300 volts. In an alternate example, the cut-off electrode 95, instead of having applied thereto voltage pulses, is maintained at a positive voltage, of e.g. a few volts. This low positive voltage prevents the slow ions produced at the end of the pulse in the ion source from leaving the ion source, and thus allows truncation of the terminal part of the ion beam, which in turn provides a sharp cut-off at the end of the neutron pulse (i.e. a short fall time). The cut-off electrode 95 is preferably made of a metallic grid in the form of a truncated sphere, and its concavity directed toward the target 73. Part of the cut-off electrode 95 might protrude inside the cylindrical hollow anode 57.

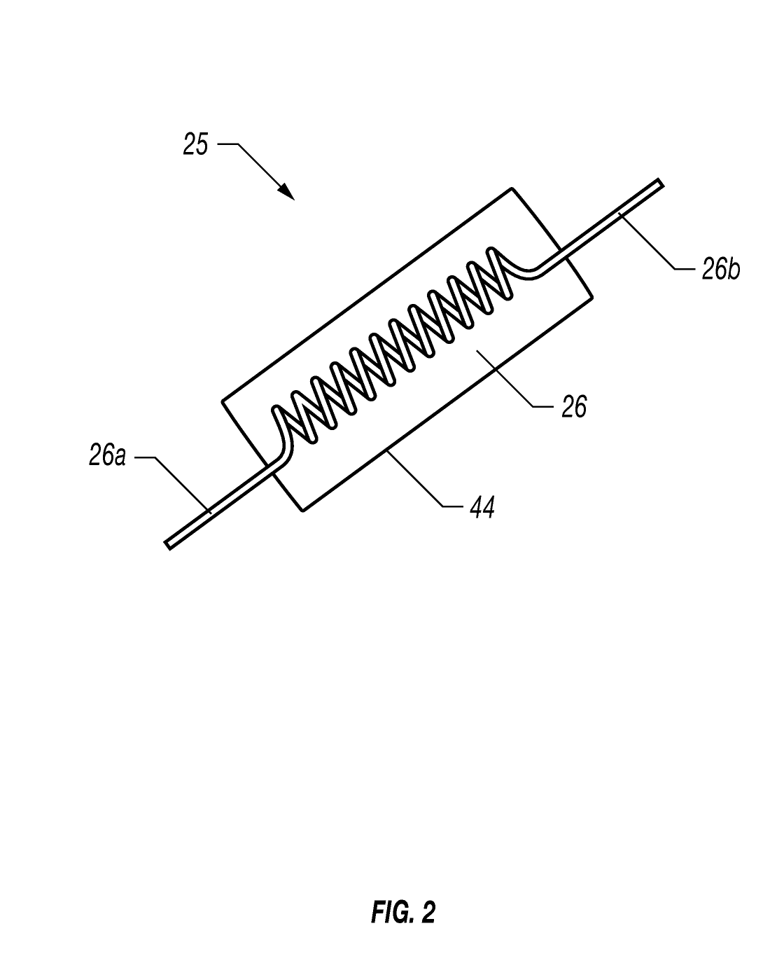

Having explained an example structure for a neutron tube, an example structure of the gas reservoir 25, being a combination of the filament 26 and getter 44 will be explained in more detail with reference to FIG. 2. Ends of the filament 26 are shown at 26a and 26b. The filament 26, as previously explained, may be a wire coil made from tungsten, titanium, monel or other partially resistive metal that can heat upon application of electric current. The getter material 44 may be formed around the filament 26, or the filament 26 may be cast or sintered in place therein.

The getter 44 may be made from a sintered, porous material having therein interspersed particles of titanium and molybdenum. Such material is sold in the form of completed getters by, SAES GETTERS S.pA., Via Gallarate 215. 20151 Milan, Italy under product designation S5K0370. The getter 44 material is typically used to adsorb molecules containing hydrogen, carbon and/or oxygen to maintain high vacuum. Such use and the performance of the foregoing material is described in, for example, E Giorgi, C Boffito and M Bolognesi, A new Ti-based non-evaporable getter, Vacuum, vol. 41, number 7-9, pp. 1935 to 1937 (1990). A gas reservoir made as explained herein may have the advantages of lower power consumption by the filament, and greater resistance to shock and vibration than filament gas reservoirs known in the art. While the present example includes titanium particles interspersed in the sintered, porous getter material, in other examples other known thermally reversible hydride-adsorptive material particles may be interspersed in the sintered getter material. Examples of the foregoing hydride-adsorptive material include, without limitation zirconium, scandium, erbium, yttrium and vanadium

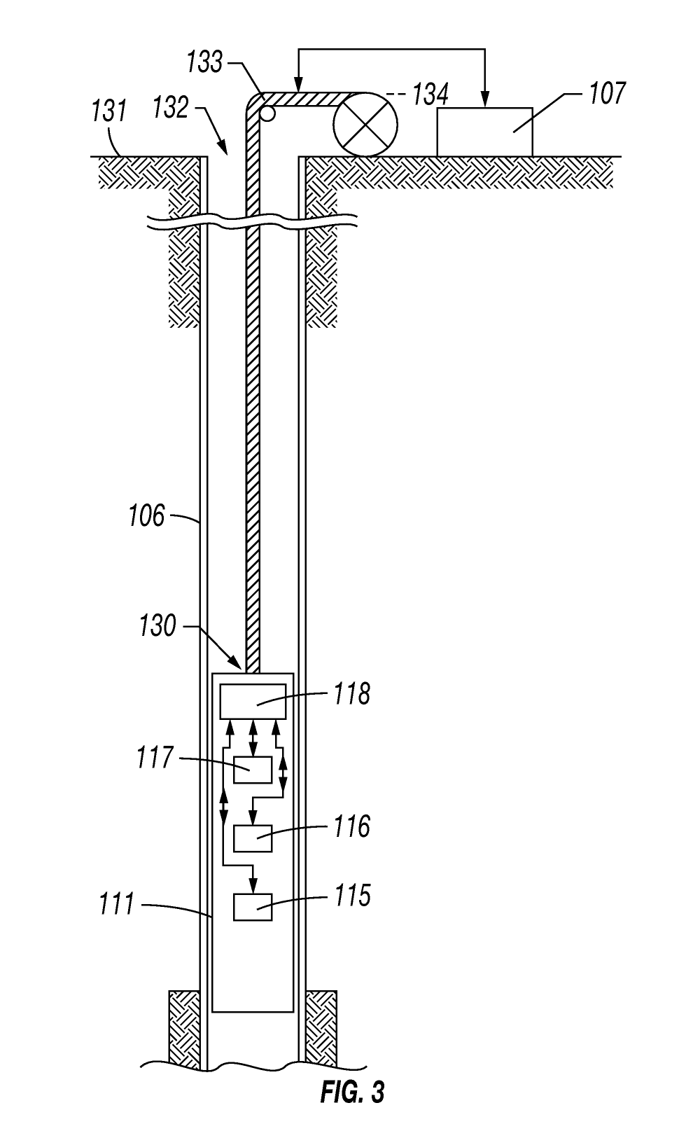

FIG. 3 shows an example apparatus for evaluating subsurface formations 131 traversed by a wellbore 132, which can use a neutron tube as explained with reference to FIGS. 1 and 2. The wellbore 132 is typically, but not necessarily filled with a drilling fluid or “drilling mud” which contains finely divided solids in suspension. Deposits of mud solids may deposit on the walls of permeable formations in the wellbore 132 to form mudcake 106. A pulsed neutron logging instrument 130 may be suspended in the wellbore 32 on an armored electrical cable 133, the length of which substantially determines the relative depth of the instrument 130. As is known in the art, this type of instrument can also operate in a well having casing or tubing inserted therein. The length of cable 133 is controlled by suitable means at the surface such as a drum and winch mechanism 134. The depth of the instrument 130 within the wellbore 132 can be measured by encoders in an associated sheave wheel 133, wherein the double-headed arrow represents communication of the depth level information to the surface equipment. Surface equipment, represented at 107, can be of conventional type, and can include a processor subsystem and recorder, and communicates with the all the downhole equipment. It will be understood that processing can be performed downhole and/or at the surface, and that some of the processing may be performed at a remote location. Although the instrument 130 is shown as a single body, the instrument 130 may alternatively comprise separate components such as a cartridge, sonde or skid, and the tool may be combinable with other logging tools. The pulsed neutron well logging instrument 130 may, in a form hereof, be of a general type described for example, in U.S. Pat. No. 5,699,246. The instrument 130 may include a housing 111 in the shape of a cylindrical sleeve, which is capable, for example, of running in open wellbore, cased wellbore or production tubing. Although not illustrated in FIG. 3, the instrument 130 may also have an eccentering device, for forcing the instrument 130 against the wall of an open wellbore or against wellbore casing. At least one pulsed neutron generator 115, which may be of the type shown in and explained with reference to FIGS. 1 and 2 may be mounted in the housing 111 with a near-spaced radiation detector 116 and a far-spaced radiation detector 117 mounted longitudinally above the PNG 115, each at a separate axial distance therefrom. One or more further detectors (not shown) can also be provided, it being understood that when the near and far detectors are referenced, use of further detectors can, whenever suitable, be included as well. Also, it can be noted that a single radiation detector could be used. Acquisition, control, and telemetry electronics 118 serves, among other functions, to control the timing of burst cycles of the PNG 115, the timing of detection time gates for the near 116 and far 117 radiation detectors and to telemeter count rate and other data using the cable 133 and surface telemetry circuitry, which can be part of the surface instrumentation 107. The surface processor of surface instrumentation 107 can, for example, receive detected thermal neutron counts, detected epithermal neutron counts and/or gamma ray spectral data from near and far radiation detectors 116 and 117. The signals can be recorded as a “log” representing measured parameters with respect to depth or time on, for example, a recorder in the surface instrumentation 107. The radiation detectors may include one or more of the following types of radiation detectors, thermal neutron detectors (e.g., ³He proportional counters), epithermal neutron detectors and scintillation counters (which may or may not be used in connection with a spectral analyzer).

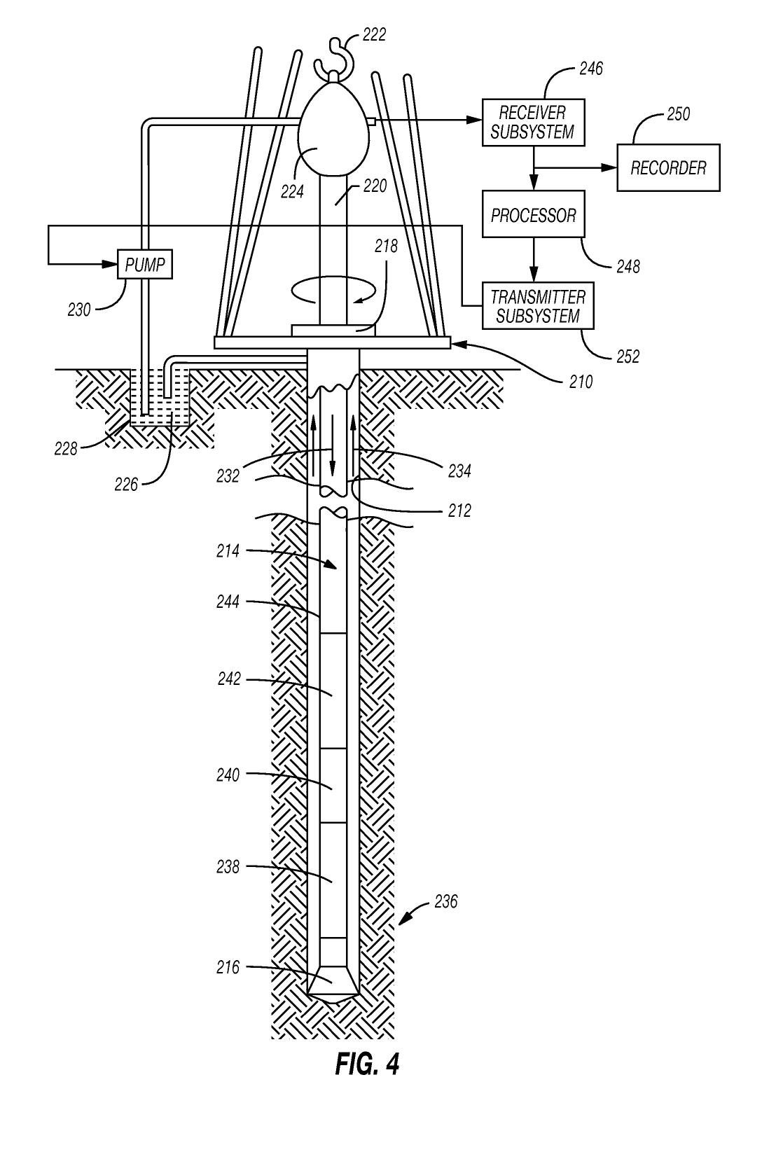

The PNG which uses the neutron tube described with reference to FIGS. 1 and 2 can also be used, for example, in logging-while-drilling (“LWD”) equipment. As shown, for example, in FIG. 4, a platform and derrick 210 are positioned over a wellbore 212 that may be formed in the Earth by rotary drilling. A drill string 214 may be suspended within the borehole and may include a drill bit 216 attached thereto and rotated by a rotary table 218 (energized by means not shown) which engages a kelly 220 at the upper end of the drill string 214. The drill string 214 is typically suspended from a hook 222 attached to a traveling block (not shown). The kelly 220 may be connected to the hook 222 through a rotary swivel 224 which permits rotation of the drill string 214 relative to the hook 222. Alternatively, the drill string 214 and drill bit 216 may be rotated from the surface by a “top drive” type of drilling rig.

Drilling fluid or mud 226 is contained in a mud pit 228 adjacent to the derrick 210. A pump 230 pumps the drilling fluid 226 into the drill string 214 via a port in the swivel 224 to flow downward (as indicated by the flow arrow 232) through the center of the drill string 214. The drilling fluid exits the drill string via ports in the drill bit 216 and then circulates upward in the annular space between the outside of the drill string 214 and the wall of the wellbore 212, as indicated by the flow arrows 234. The drilling fluid 226 thereby lubricates the bit and carries formation cuttings to the surface of the earth. At the surface, the drilling fluid is returned to the mud pit 228 for recirculation. If desired, a directional drilling assembly (not shown) could also be employed.

A bottom hole assembly (“BHA”) 236 may be mounted within the drill string 214, preferably near the drill bit 216. The BHA 236 may include subassemblies for making measurements, processing and storing information and for communicating with the Earth's surface. The bottom hole assembly is typically located within several drill collar lengths of the drill bit 216. In the illustrated BHA 236, a stabilizer collar section 238 is shown disposed immediately above the drill bit 216, followed in the upward direction by a drill collar section 240, another stabilizer collar section 242 and another drill collar section 244. This arrangement of drill collar sections and stabilizer collar sections is illustrative only, and other arrangements of components in any implementation of the BHA 236 may be used. The need for or desirability of the stabilizer collars will depend on drilling conditions.

In the arrangement shown in FIG. 4, the components of a downhole pulsed neutron measurement subassembly that may include a neutron tube as explained with reference to FIGS. 1 and 2 and may be located in the drill collar section 240 above the stabilizer collar 238. Such components could, if desired, be located closer to or farther from the drill bit 216, such as, for example, in either stabilizer collar section 238 or 242 or the drill collar section 244. The drill collar section 240 may include one or more radiation detectors (not shown in FIG. 4) substantially as explained with reference to FIG. 3.

The BHA 236 may also include a telemetry subassembly (not shown) for data and control communication with the Earth's surface. Such telemetry subassembly may be of any suitable type, e.g., a mud pulse (pressure or acoustic) telemetry system, wired drill pipe, etc., which receives output signals from LWD measuring instruments in the BHA 236 (including the one or more radiation detectors) and transmits encoded signals representative of such outputs to the surface where the signals are detected, decoded in a receiver subsystem 246, and applied to a processor 248 and/or a recorder 250. The processor 248 may comprise, for example, a suitably programmed general or special purpose processor. A surface transmitter subsystem 252 may also be provided for establishing downward communication with the bottom hole assembly.

The BHA 236 can also include conventional acquisition and processing electronics (not shown) comprising a microprocessor system (with associated memory, clock and timing circuitry, and interface circuitry) capable of timing the operation of the accelerator and the data measuring sensors, storing data from the measuring sensors, processing the data and storing the results, and coupling any desired portion of the data to the telemetry components for transmission to the surface. Alternatively, the data may be stored downhole and retrieved at the surface upon removal of the drill string. Power for the LWD instrumentation may be provided by battery or, as known in the art, by a turbine generator disposed in the BHA 236 and powered by the flow of drilling fluid.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A pulsed neutron generator, comprising:
a sealed tube;
a gas reservoir disposed in the sealed tube, the gas reservoir including an electrically heatable filament disposed within a porous, sintered getter, the getter comprising dispersed particles of a thermally reversible hydride-adsorptive material therein, the material particles having adsorbed therein deuterium and/or tritium;
a gas ionizer disposed in the sealed tube;
a target disposed in the sealed tube, the target including adsorbed deuterium and/or tritium therein.

2. The pulsed neutron generator of claim 1 wherein the dispersed particles comprise titanium.

3. The pulsed neutron generator of claim 1 wherein the dispersed particles comprise at least one of scandium, yttrium, vanadium and erbium.

4. The pulsed neutron generator of claim 1 wherein the dispersed particles comprise zirconium.

5. The pulsed neutron generator of claim 1 wherein the gas ionizer comprises a cathode and an anode electrically connected to an ionization power supply.

6. The pulsed neutron generator of claim 1 wherein the filament is electrically connected to a controllable electric power supply configured to maintain a pressure of deuterium and/or tritium gas in the tube at a selected pressure.

7. The pulsed neutron generator of claim 1 further comprising a high voltage power supply electrically connected to the target such that gas ions generated by the gas ionizer are accelerated toward the target to induce a reaction thereon that produces free neutrons.

8. The pulsed neutron generator of claim 1 wherein the pulsed neutron generator is disposed in a well logging instrument housing configured to traverse a wellbore drilled through subsurface formations.

9. The pulsed neutron generator of claim 6 wherein the housing comprises at least one radiation detector disposed in the housing axially spaced apart from the pulsed neutron generator.

10. A pulsed neutron well logging instrument, comprising:
a pressure resistant housing configured to traverse a wellbore drilled through subsurface formations;
a pulsed neutron generator disposed in the housing, the pulsed neutron generator including a gas reservoir having an electrically heated filament surrounded by a porous, sintered getter having therein dispersed particles of a thermally reversible hydride-adsorptive material;
at least one radiation detector disposed in the housing axially spaced apart from the pulsed neutron generator; and
a signal processor disposed in the housing, the signal processor configured to perform at least one of, quantifying numbers and/or energy levels of nuclear events resulting from interaction of neutrons from the neutron generator with formations adjacent the wellbore and encoding signals from the at least one radiation detector for transmission to the Earth's surface.

11. The pulsed neutron well logging instrument of claim 10 wherein the dispersed particles comprise titanium

12. The pulsed neutron well logging instrument of claim 10 wherein the dispersed particles comprise at least one of scandium, yttrium, vanadium and erbium.

13. The pulsed neutron well logging instrument of claim 10 wherein the dispersed particles comprise zirconium.

14. The pulsed neutron well logging instrument of claim 10 wherein the housing is coupled to an armored electrical cable, the cable extendable into and retractable from the wellbore by a winch.

15. The pulsed neutron well logging instrument of claim 10 wherein the housing comprises a drill collar, the drill collar configured to form part of a bottom hole assembly in a drill string extendable into and retractable from the wellbore.

16. The pulsed neutron well logging instrument of claim 10 wherein the at least one radiation detector comprises at least one of a thermal neutron detector, an epithermal neutron detector and a scintillation counter.

17. A method for generating neutrons, comprising:
filling an evacuated, sealed envelope with deuterium and/or tritium gas to a selected pressure by heating a sintered, porous getter having deuterium and/or tritium adsorbed in thermally reversible hydride-adsorptive particles dispersed in the getter;
ionizing the deuterium and/or tritium gas; and
accelerating the ionized gas to strike a target in the sealed envelope, the target having adsorbed deuterium and/or tritium therein, whereby the accelerated ions react with the adsorbed deuterium and/or tritium in the target to release free neutrons.

18. The method of claim 17 wherein heating the getter comprises operating an electrical heating element disposed within the getter.

19. The method of claim 17 wherein the ionizing the gas comprises applying voltage pulses between a cathode and an anode disposed in the envelope.

20. The method of claim 17 wherein the accelerating the ionized gas toward the target comprises applying a selected voltage to the target with respect to ground.

21. The method of claim 17 wherein the dispersed particles comprise titanium

22. The method of claim 17 wherein the dispersed particles comprise at least one of scandium, yttrium, vanadium and erbium.

23. The method of claim 17 wherein the dispersed particles comprise zirconium.

24. A method for well logging comprising:
moving a well logging instrument along an interior of a wellbore penetrating subsurface formations;
emitting neutrons into the formations from a pulsed neutron source, the emitting neutrons comprising filling an evacuated, sealed envelope with deuterium and/or tritium gas to a selected pressure by heating a sintered, porous getter having deuterium and/or tritium adsorbed in thermally reversible hydride-adsorptive particles dispersed in the getter, ionizing the deuterium and/or tritium gas and accelerating the ionized gas to strike a target in the sealed envelope, the target having adsorbed deuterium and/or tritium therein, whereby the accelerated ions react with the adsorbed deuterium and/or tritium in the target to release neutrons;
detecting radiation resulting from interaction of the neutrons with the formations; and
making a record with respect to at least one of depth and time of the detected radiation.

25. The method of claim 24 wherein heating the getter comprises operating an electrical heating element disposed within the getter.

26. The method of claim 24 wherein the ionizing the gas comprises applying voltage pulses between a cathode and an anode disposed in the envelope.

27. The method of claim 24 wherein the accelerating the ionized gas toward the target comprises applying a selected voltage to the target with respect to ground.

28. The method of claim 24 wherein the detecting comprises at least one of detecting thermal neutrons, detecting epithermal neutrons and detecting gamma rays.

29. The method of claim 24 wherein the dispersed particles comprise titanium

30. The method of claim 24 wherein the dispersed particles comprise at least one of scandium, yttrium, vanadium and erbium.

31. The method of claim 24 wherein the dispersed particles comprise zirconium.
